(19) United States
(12) Patent Application Publication
(10) Pub. No.: US 2026/0014912 A1
(43) Pub. Date: Jan. 15, 2026

(54) HEAD RESTRAINT FOR A VEHICLE SEAT WITH A HEAD RESTRAINT GUIDE ARRANGEMENT AND HEAD RESTRAINT GUIDE ARRANGEMENT FOR A HEAD RESTRAINT

(71) Applicant: ILLINOIS TOOL WORKS INC., Glenview, IL (US)

(72) Inventors: Dennis MARK, Hawthorn Woods, IL (US); Jorge Adolfo MIRANDA NIETO, Barcelona (ES); David MONTES COBO, Sabadell (ES)

(21) Appl. No.: 19/252,278

(22) Filed: Jun. 27, 2025

Related U.S. Application Data
(60) Provisional application No. 63/668,820, filed on Jul. 9, 2024.

(51) Int. Cl. B60N 2/815

(52) U.S. Cl. CPC B60N 2/815

(57) ABSTRACT

A headrest for a vehicle seat, wherein the headrest has two headrest rods which extend at least substantially parallel and on which a head cushion of the headrest is arranged or can be arranged. The headrest furthermore has a locking mechanism which can be actuated, in particular manually, and which in its locked state acts exclusively on only one of the two headrest rods, the locking mechanism having a pivot lever which is designed in such a way that when the pivot lever is actuated, engagement between an engagement element and the one headrest rod is released.

### TECHNICAL FIELD

The present invention relates to generally adjustable headrest arrangements for a vehicle seat, in particular a motor vehicle seat. In particular, the invention relates to head restraints for a vehicle seat with a special head restraint guide arrangement and to a head restraint guide arrangement for such head restraints.

### BACKGROUND

Head restraints are an essential part of the passive safety system in vehicles and serve to reduce the impact of forces on the cervical spine in the event of a sudden change in vehicle movement, particularly in the event of a traffic accident. In addition to improving the safety of vehicle occupants, headrests also serve to increase comfort.

Headrests are generally designed to be adjustable so that they can perform these functions and be individually adapted to different vehicle occupants in terms of their position. Various designs and variants are known with regard to the adjustment options.

Headrests are usually at least height-adjustable and can be mechanically locked in different positions. For this purpose, the headrests have headrest rods with latching points and a padded support structure (head cushion), which are held in corresponding receptacles in the vehicle seat.

In the case of mechanically adjustable headrests, it is particularly important that the operation and adjustability for a vehicle occupant is quick, easy and requires little effort, and that an optimum, individual adjustment to different occupants can be achieved. Furthermore, the headrests should be easy and inexpensive to manufacture and install.

Known headrest arrangements, which in particular have a height adjustment and are simple to operate, are usually designed with an adjustment mechanism that has a large number of components, for example gear components. This requires a great deal of assembly work and expense.

### SUMMARY

One task of the present invention is to provide a headrest arrangement for a vehicle, wherein the headrest can be safely, easily and quickly adjusted to an optimum position for the vehicle occupant and is simple to manufacture and assemble and can be realized at low cost.

Accordingly, the invention relates in particular to a headrest for a vehicle seat, wherein the headrest has two headrest rods or headrest rod sections which extend at least substantially parallel and on which a head cushion of the headrest is arranged or can be arranged.

The head restraint according to the invention also has a head restraint guide arrangement by means of which the head restraint rods or head restraint rod sections are accommodated or can be accommodated on and, in particular, in a seat back of the vehicle seat in such a way that the head restraint rods or head restraint rod sections are aligned with the head cushion of the head restraint, which may be arranged on the head restraint rods or head restraint rod sections, in a longitudinal extension direction of the head restraint rods or head restraint rod sections. headrest upholstery of the headrest, which may be arranged on the headrest rods or headrest rod sections, can be adjusted and, in particular, displaced in a longitudinal direction of extension of the headrest rods or headrest rod sections relative to the headrest guide arrangement between a first position and at least one second position.

To determine an adjustment position of the head restraint, a locking mechanism is used, in particular a manually operated locking mechanism, which can be switched between a first state and a second state. The first state of the locking mechanism corresponds to a locked state in which the adjustability of the headrest rods or headrest rod sections relative to the headrest guide arrangement is blocked. On the other hand, the second locking state corresponds to an unlocked state in which the head restraint rods or head restraint rod sections can be adjusted relative to the head restraint guide arrangement.

The invention is characterized in particular by the fact that the locking mechanism, which can be actuated manually in particular, acts exclusively on only one of the two headrest rods or headrest rod sections, especially in its first state.

The fact that the locking mechanism is only assigned to one of the two headrest rods or headrest rod sections simplifies the design of the entire headrest arrangement. In particular, the headrest arrangement can be realized with a particularly small number of components.

According to implementations of the present invention, it is provided that the locking device, which can be actuated in particular manually, has an engagement element which, in the first state of the locking device, is in engagement with one of the two headrest rods or with one of the two headrest rod sections. In addition, it is useful for the locking mechanism to have a pretensioning element which pretensions the locking mechanism into its first state.

According to further embodiments of the last-mentioned embodiment variant, it is provided that the locking device, which can be actuated in particular manually, has a pivot lever which is mounted so as to be pivotable about an axis of rotation and is designed in such a way that when the pivot lever is actuated or rotated, the locking device is transferred to its second state and an engagement between the engagement element and the one headrest rod or the one headrest rod section is released.

The pretensioning element preferably has a dual function: on the one hand, the pretensioning element serves to pretension the locking mechanism into its first state. On the other hand, the pretensioning element is preferably designed to pretension the swivel lever into its unactuated position.

In particular, the pretensioning element is designed as a compression spring, although other design variants are also conceivable.

According to preferred implementations of the headrest according to the invention, it is provided that the engagement element is designed as a lever element which is rotatable about an axis of rotation. The axis of rotation, about which the engagement element is rotatable, runs in particular parallel to the longitudinal direction of extension of the headrest rods.

The rotatable lever element is designed in such a way that, in the first locking state, it engages with the headrest rod in an adjustment notch of the one headrest rod. It should be noted here that the headrest rod does not necessarily have to be designed with corresponding adjustment notches.

In particular, the lever element and the swivel lever are designed as an essentially L-shaped, monolithic injection-molded plastic part.

In this context, it is conceivable that the swivel lever can be swiveled about an axis of rotation, preferably parallel to the longitudinal direction of the headrest rods, against the force of the pretensioning element in order to transfer the locking mechanism to its second state.

In this context, it is useful for the locking device to have a housing in which at least one actuating area of the pivot lever is accommodated at least partially or in certain areas, whereby the actuating area of the pivot lever can be pivoted at least partially into the housing in order to transfer the locking device into its second state by exerting a compressive force on the actuating area of the pivot lever.

Alternatively, however, it is also conceivable that the locking device has a housing in which at least one actuating region of the pivot lever is accommodated at least partially or in some areas, whereby the actuating region of the pivot lever can be pivoted at least partially out of the housing in order to transfer the locking device to its second state by exerting a tensile force on the actuating region of the pivot lever.

With regard to the engagement element of the head restraint according to the invention, it is particularly preferred that this has a through-opening through which the one head restraint rod or the one head restraint rod section is guided.

According to embodiments of the head restraint according to the invention, it is provided in this context that a wall region of the passage opening facing the rotary knob has a complementary contour which is at least partially or partially adapted to the shaping, in particular cross-sectional shaping, of the one head restraint rod or of the one head restraint rod section.

The headrest guide arrangement preferably has a first guide sleeve body, which is assigned to a first headrest rod or a first headrest rod section of the two headrest rods or the two headrest rod sections, and in which the first headrest rod or the first headrest rod section is accommodated or can be accommodated at least partially or in regions.

In the same way, it is suitable that the headrest guide arrangement further comprises a second guide sleeve body which is associated with a second headrest rod or a second headrest rod section of the two headrest rods or the two headrest rod sections, and in which the second headrest rod or the second headrest rod section is accommodated or can be accommodated at least in part or in a region.

Preferably, the headrest guide arrangement has a tolerance compensation to compensate for any existing tolerance fluctuations between the distances between the two headrest rods or headrest rod sections, which run at least essentially parallel.

According to embodiments of the headrest according to the invention, it is provided that the first guide sleeve body is accommodated or can be accommodated at least partially or in a region in a first receptacle designed in or on the seat back of the vehicle seat. In the same way, the second guide sleeve body can be accommodated or can be accommodated at least partially or in a region in a second receptacle designed in or on the seat back of the vehicle seat.

To compensate for any existing tolerance fluctuations between the distances between the two headrest rods or headrest rod sections, which run at least substantially parallel, the first receptacle has a cross-sectional geometry and size as tolerance compensation, which corresponds to the cross-sectional geometry and size of the first guide sleeve, while the second receptacle has a slot-shaped In order to compensate for any tolerance variations between the two at least substantially parallel head restraint rods or head restraint rod sections, the first receptacle has a cross-sectional geometry and size as tolerance compensation which corresponds to the cross-sectional geometry and size of the first guide sleeve, while the second receptacle has an elongated hole-shaped cross-sectional geometry, wherein the longitudinal sides of the elongated hole extend in the direction of the first receptacle and the narrow sides of the elongated hole are terminated by semicircles whose diameter corresponds to the width of the elongated hole and are adapted to the size and cross-sectional geometry of the second guide sleeve.

Alternatively or additionally, it is conceivable that the first guide sleeve body has an inner axial passage which is designed to receive at least partially or in some areas the first head restraint rod or the first head restraint rod section, wherein the second guide sleeve body also has an inner axial passage which is designed to receive at least partially or in some areas the second head restraint rod or the second head restraint rod section.

To compensate for any existing diameter tolerances, the axial passage of the first guide sleeve body should have a cross-sectional geometry and size which corresponds to the cross-sectional geometry and size of the first head restraint rod or the first head restraint rod section, while the axial passage of the second guide sleeve body has an elongated hole-shaped cross-sectional geometry at least in some areas, with the longitudinal sides of the elongated hole of the first head restraint rod or the first head restraint rod section, while the axial passage of the second guide sleeve body has an elongated hole-shaped cross-sectional geometry, at least in some areas, with the longitudinal sides of the elongated hole extending in the direction of the first guide sleeve body and the narrow sides of the elongated hole being terminated by semicircles whose diameter corresponds to the width of the elongated hole and is adapted to the size and cross-sectional geometry of the second head restraint rod or the second head restraint rod section.

However, an egg-shaped cross-sectional geometry or similar is also conceivable as an alternative to an elongated hole-shaped cross-sectional geometry.

Preferably, a diameter tolerance compensation for the corresponding headrest rod or for the corresponding headrest rod section is assigned to the two guide sleeve bodies. In this case, it is suitable for the diameter tolerance compensation to have at least one resilient clement, which is arranged on the outer surface or inner surface of the first or second guide sleeve body. The at least one resilient element can be designed as an elastomer element.

### BRIEF DESCRIPTION OF THE DRAWINGS

In the following, with reference to the accompanying drawings, embodiments of the head restraint or head restraint guide arrangement according to the invention are described in more detail.

The following are shown:

FIG. 1 is a schematic and isometric view of a first exemplary embodiment of a headrest guide arrangement of the headrest according to the invention;

FIG. 2 is a schematic and isometric view of a second exemplary embodiment of a headrest guide arrangement of the headrest according to the invention;

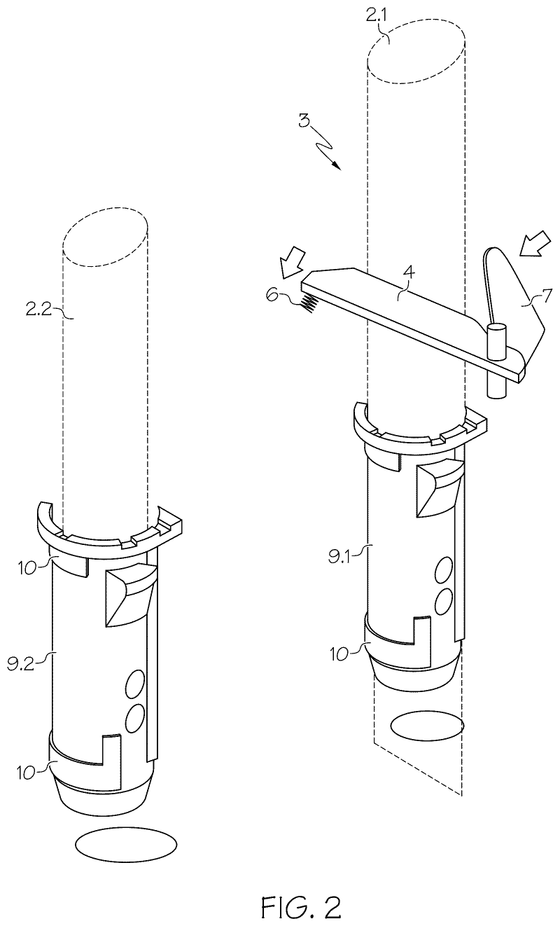

FIG. 3 shows schematically and in an isometric view an exemplary embodiment of the headrest according to the invention with a third exemplary embodiment of a corresponding headrest guide arrangement;

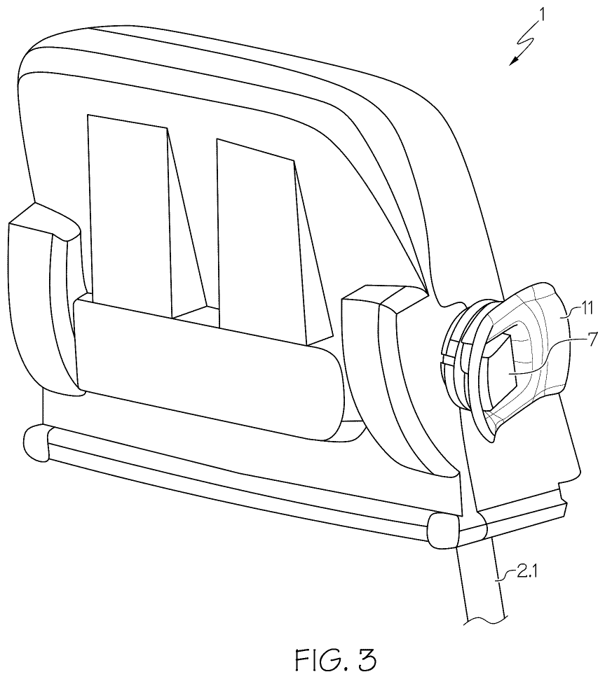

FIG. 4 shows schematically and in an isometric exploded view of the embodiment of the headrest according to the invention as shown in FIG. 3;

FIG. 5 shows schematically and in a partially sectioned view an image sequence in which the locking device used in the headrest arrangement according to FIG. 4 shifts from its first state (locked state) and into its second state (unlocked state); and

FIG. 6 shows schematic and partially sectioned view an image sequence of an alternative embodiment of the locking mechanism used in the head restraint arrangement according to FIG. 4 and in which the locking device shifts from its first state (locked state) and into its second state (unlocked state).

### DETAILED DESCRIPTION

The exemplary embodiments of the head restraint 1 or the head restraint guide arrangement according to the invention, as shown in the accompanying drawings, are characterized in that a manually operable locking mechanism 3 is used, which can be transferred between a first state and a second state, the first state of the locking mechanism 3 corresponding to a locking state in which adjustability of the head restraint rods 2.1, 2.2 relative to the head restraint guide arrangement is blocked, and wherein the second state of the locking mechanism 3 corresponds to an unlocked state in which the head restraint rods 2.1, 2.2 can be adjusted relative to the head restraint guide arrangement. In its first state, the manually operable locking mechanism 3 acts exclusively on only one of the two headrest rods 2.1, 2.2 of the headrest 1.

For this purpose, the locking mechanism 3 has an engagement element 4 which, in the first state of the locking mechanism 3, is in engagement with one of the two headrest rods 2.1, 2.2. Furthermore, the locking mechanism 3 comprises a pretensioning clement 6 (spring), which pretensions the locking mechanism 3 into its first state.

The embodiments of the head restraint arrangement according to the invention shown in the drawings are further characterized in that the locking mechanism 3 has a pivot lever 7 which is designed in such a way that when the pivot lever 7 is actuated, i.e. rotated, the locking mechanism 3 is transferred to its second state and an engagement between the engagement element 4 and the one head restraint rod 2.1 is released. The aforementioned pretensioning element 6 also serves to pretension the swivel lever 7 into its non-actuated position.

As can be seen from the drawings, the pretensioning element 6 is designed as a compression spring.

In detail, the engagement element 4 is designed as a lever element that can rotate about an axis of rotation. The axis of rotation runs parallel to the longitudinal direction of the headrest rods 2.1, 2.2.

In the first state of the locking mechanism 3, the engagement element 4, designed as a lever element, is in engagement with the headrest rod 2.1, preferably in an adjustment notch 8 of the headrest rod 2.1.

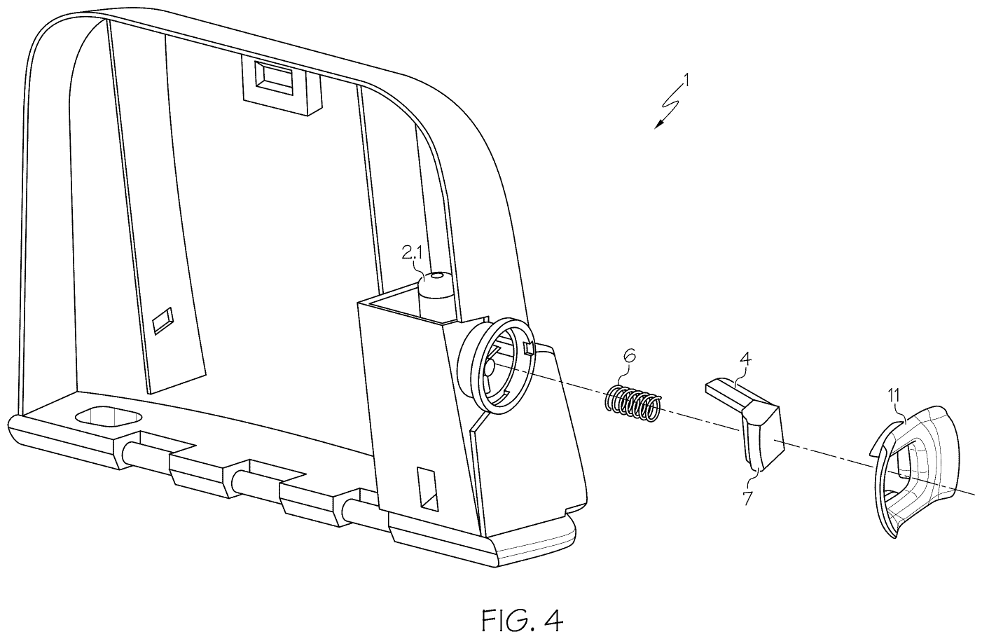

In particular, it can be seen from the exploded view according to FIG. 4 that the lever element and the swivel lever 7 are designed in particular as an essentially L-shaped component. This is preferably a monolithic injection-molded plastic part.

The pivoting lever 7 can be pivoted against the force of the pretensioning element 6 about an axis of rotation running parallel to the longitudinal direction of the headrest rods 2.1, 2.2 in order to move the locking mechanism 3 into its second state.

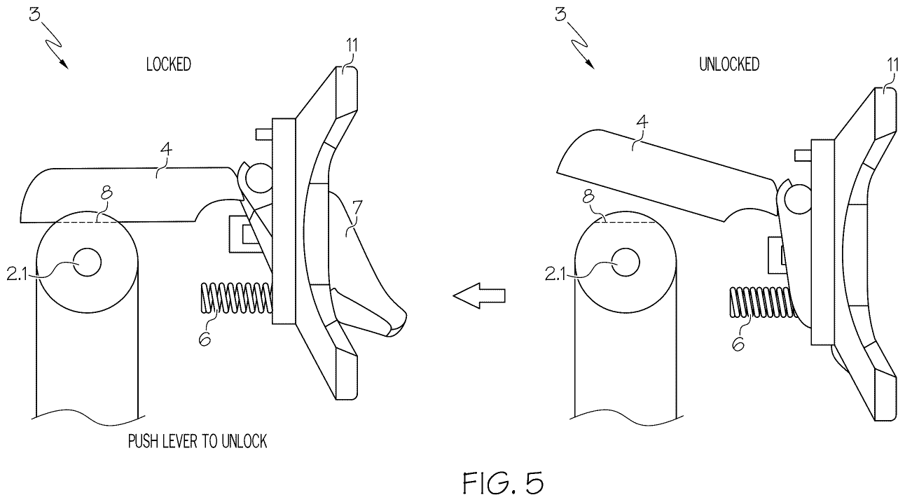

As can be seen in particular from the representation in FIG. 5, the locking device 3 can have a housing 11, in which at least one actuating region of the pivot lever 7 is accommodated at least partially or in certain regions, wherein, in order to transfer the locking device 3 into its second state, the actuating region of the pivot lever 7 (and thus also the pivot lever 7) can be pivoted at least partially into the housing 11, namely by exerting a compressive force on the actuating region of the pivot lever 7.

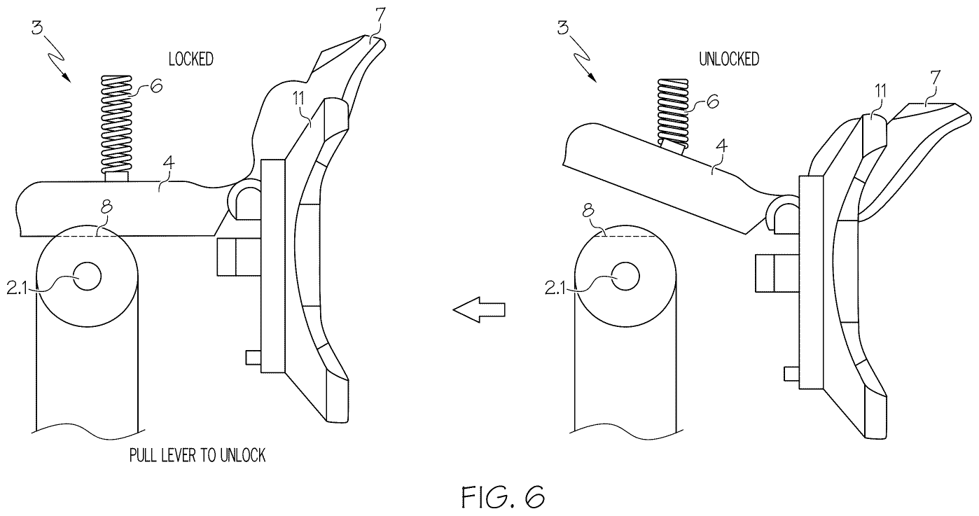

Alternatively, and as indicated in FIG. 6, the locking device 3 can have a housing 11 in which at least one actuating region of the pivot lever 7 is accommodated at least partially or in certain regions, wherein the actuating region of the pivot lever 7 (and thus also the pivot lever 7) can be pivoted at least partially out of the housing 11 in order to transfer the locking device 3 into its second state by exerting a tensile force on the actuating region of the pivot lever 7.

The headrest guide arrangements of the embodiments shown in the drawings each have a first guide sleeve body 9.1 and a second guide sleeve body 9.2. The first guide sleeve body 9.1 is assigned to a first head restraint rod 2.1 of the two head restraint rods 2.1, 2.2, wherein the first head restraint rod 2.1 is accommodated or can be accommodated in the first guide sleeve body 9.1 at least in part or in a region.

In the same way, the second guide sleeve body 9.2 is assigned to a second head restraint rod 2.2 of the two head restraint rods 2.1, 2.2, wherein the second head restraint rod 2.2 is accommodated or can be accommodated in the second guide sleeve body 9.2 at least in part or in a region.

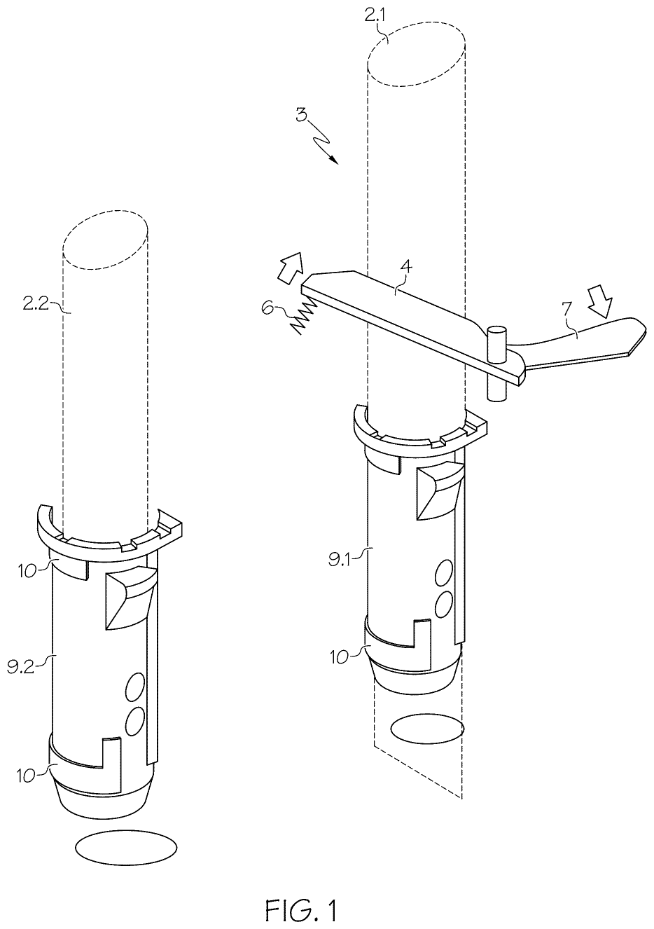

In the embodiment shown in FIG. 1, the head restraint guide arrangement has a tolerance compensation to compensate for any tolerance fluctuations between the distances between the two head restraint rods 2.1, 2.2, which run at least substantially parallel.

In detail, with regard to tolerance compensation, it is provided that—as indicated in FIG. 1—the first guide sleeve body 9.1 has an inner axial passage which is designed to receive the first head support rod 2.1 at least partially or in certain areas, wherein the second guide sleeve body 9.2 has an inner axial passage which is designed to receive the second head support rod 2.2 at least partially or in certain areas, wherein, to compensate for existing diameter tolerances and/or to compensate for any existing tolerance fluctuations between the distances between the two at least substantially parallel head support rods 2.1, 2.2, the axial passage of the first guide sleeve body 9.1 has a cross-sectional geometry and size which corresponds to the cross-sectional geometry and size of the first head support rod 2.1, whereas the axial passage of the second guide sleeve body 9.2 has a cross-sectional geometry which is at least substantially elongated at least in some areas, wherein the longitudinal sides of the elongated hole extend in the direction of the first guide sleeve body 9.1 and the narrow sides of the elongated hole are terminated by semicircles, the diameter of which corresponds to the width of the elongated hole and is adapted to the size and cross-sectional geometry of the second headrest rod 2.2.

In the embodiments shown in the drawings, the guide sleeve bodies 9.1, 9.2 of the headrest guide arrangements are designed with an integrated diameter tolerance compensation. In detail, the diameter tolerance compensation is formed by at least one resilient element 10, which is formed on the outer surface or inner surface of the corresponding guide sleeve body 9.1, 9.2.

The invention is not limited to the embodiments shown in the drawings, but results from a synopsis of all the features disclosed herein.

### LIST OF REFERENCE SIGNS

1 headrest

2.1 first headrest bar

2.2 second headrest bar

3 locking

4 intervention element

6 preload element

7 swivel lever

8 adjustment notch

9.1 first guide sleeve body

9.2 second guide sleeve body

10 spring element/elastomer element

11 housing

1. A headrest for a vehicle seat, wherein the headrest comprises the following:
two headrest rods extending at least substantially parallel, on which a head cushion of the headrest is arranged or can be arranged;
a headrest guide arrangement, by means of which the headrest rods are accommodated or can be accommodated on in a seat back of the vehicle seat in such a way that the headrest rods with the head cushion of the headrest, which may be arranged on the headrest rods are displaceable relative to the headrest guide arrangement between a first position and at least a second position in a longitudinal extension direction of the headrest rods or the headrest rod sections; and
a locking mechanism which can be actuated, manually, and which can be transferred between a first state and a second state, the first state of the locking mechanism corresponding to a locked state in which adjustability of the headrest rods relative to the head restraint guide arrangement is blocked, and wherein the second state of the locking mechanism corresponds to an unlocked state in which the head restraint rods can be adjusted relative to the head restraint guide arrangement;
wherein the locking mechanism, which can be actuated manually, acts exclusively on only one of the two headrest rods, especially in its first state.

2. The headrest according to claim 1,
wherein the locking device, which can be actuated manually, has an engagement element, which in the first state of the locking device is in engagement with one of the two head restraint rods, and a pretensioning element, which pretensions the locking device into its first state.

3. The headrest according to claim 2,
wherein the locking device, which can be actuated manually, has a pivot lever which is mounted so as to be pivotable about an axis of rotation and is designed in such a way that when the pivot lever is pivoted, the locking device is transferred to its second state and an engagement between the engagement element and the one headrest rod is released.

4. The headrest according to claim 3,
wherein the pretensioning element is designed to pretension the swivel lever into its unactuated position.

5. The headrest according to claim 3,
wherein the pre-tensioning element is designed as a compression spring.

6. The headrest according to claim 3,
wherein the engagement element is designed as a lever element which is rotatable about an axis of rotation which preferably extends parallel to the longitudinal direction of extension of the head restraint rods and which, in the first state of the locking mechanism, is in engagement with the head restraint rod in an adjusting notch of the one head restraint rod.

7. The headrest according to claim 6,
wherein the lever element and the swivel lever are preferably designed as an L-shaped, monolithic injection-molded plastic part.

8. The headrest according to claim 6,
wherein the pivot lever is pivotable about an axis of rotation extending preferably parallel to the longitudinal direction of extension of the headrest rods against the force of the pretensioning element in order to transfer the locking mechanism into its second state.

9. The headrest according to claim 8,
wherein the locking device has a housing in which at least one actuating region of the pivot lever is accommodated at least partially or in certain regions, wherein the actuating region of the pivot lever can be pivoted at least partially into the housing in order to transfer the locking device into its second state by exerting a compressive force on the actuating region of the pivot lever.

10. The headrest according to claim 8,
wherein the locking device has a housing in which at least one actuating region of the pivot lever is accommodated at least partially or in certain regions, wherein the actuating region of the pivot lever can be pivoted at least partially out of the housing in order to transfer the locking device into its second state by exerting a tensile force on the actuating region of the pivot lever.

11. The headrest according to claim 1,
wherein the headrest guide arrangement has a first guide sleeve body which is associated with a first headrest rod or a first headrest rod section of the two headrest rods or of the two headrest rod sections, and in which the first headrest rod or the first headrest rod section is accommodated or can be accommodated at least partially or in regions; and
wherein the headrest guide arrangement has a second guide sleeve body, which is associated with a second headrest rod or a second headrest rod section of the two headrest rods or the two headrest rod sections, and in which the second headrest rod or the second headrest rod section is accommodated or can be accommodated at least partially or in regions.

12. The headrest according to claim 11, wherein the headrest guide arrangement has a tolerance compensation for compensating for any tolerance fluctuations between the distances between the two headrest rods which run at least substantially parallel.

13. The headrest according to claim 11, wherein the first guide sleeve body is accommodated or can be accommodated at least partially or in regions in a first receptacle formed in or on the seat back of the vehicle seat, wherein the second guide sleeve body is accommodated or can be accommodated at least partially or in certain regions in a second receptacle formed in or on the seat back of the vehicle seat, wherein, in order to compensate for any tolerance fluctuations between the distances between the two head restraint rods as tolerance compensation, the first receptacle has a cross-sectional geometry and size which corresponds to the cross-sectional geometry and size of the first guide sleeve, while the second receptacle has an elongated hole-shaped cross-sectional geometry, the longitudinal sides of the elongated hole extending in the direction of the first receptacle and the narrow sides of the elongated hole being terminated by semicircles, the diameter of which corresponds to the width of the elongated hole and is adapted to the size and cross-sectional geometry of the second guide sleeve.

14. The headrest according to claim 11, wherein the first and/or second guide sleeve body has/have an inner axial passage which is designed to receive at least partially or in regions the corresponding head support rod or the corresponding headrest rod section, wherein the first and/or second guide sleeve body has a diameter tolerance compensation for the corresponding headrest rod or for the corresponding headrest rod section.

15. The headrest according to claim 14,
wherein the diameter tolerance compensation has at least one resilient element which is arranged on the outer surface or inner surface of the first or second guide sleeve body.

16. The headrest according to claim 14,
wherein the first guide sleeve body has an inner axial passage which is designed to receive at least partially or in regions the first head support rod or the first head support rod section, wherein the second guide sleeve body has an inner axial passage which is designed to receive the second head restraint rod or the second head restraint rod section at least partially or in certain regions, wherein, in order to compensate for any diameter tolerances which may be present, the axial passage of the first guide sleeve body has a cross-sectional geometry and size which correspond to the cross-sectional geometry and size of the first head restraint rod or the first head restraint rod section, while the axial passage of the second guide sleeve body has an elongated hole-shaped cross-sectional geometry at least in some areas, the longitudinal sides of the elongated hole extending in the direction of the first guide sleeve body and the narrow sides of the elongated hole being terminated by semicircles whose diameter corresponds to the width of the elongated hole and is adapted to the size and cross-sectional geometry of the second head restraint rod or the second headrest rod section.
